(19) United States
(12) Patent Application Publication
(10) Pub. No.: US 2025/0105287 A1
(43) Pub. Date: Mar. 27, 2025

(54) LITHIUM ION BATTERY AND ENERGY STORAGE DEVICE

(71) Applicant: XIAMEN HITHIUM ENERGY STORAGE TECHNOLOGY CO., LTD., Xiamen (CN)

(72) Inventors: Xiu SHEN, Xiamen (CN); Jinlan WU, Xiamen (CN); Tengxiao LV, Xiamen (CN)

(21) Appl. No.: 18/762,687

(22) Filed: Jul. 3, 2024

(30) Foreign Application Priority Data
Sep. 25, 2023 (CN) 202311243803.5

(51) Int. Cl. H01M 4/58; H01M 4/02; H01M 4/36; H01M 4/62; H01M 4/66; H01M 10/0525; H01M 10/0568

(52) U.S. Cl. CPC H01M 4/5825; H01M 4/366; H01M 4/623; H01M 4/661; H01M 10/0525; H01M 10/0568; H01M 2004/028

(57) ABSTRACT

Provided are a lithium ion battery and an energy storage device. The lithium ion battery includes a positive electrode plate, a negative electrode plate, a separator, and an electrolyte. The separator is located between the positive electrode plate and the negative electrode plate. The positive electrode plate includes a positive current collector and a positive active material layer covering the positive current collector. The positive active material layer includes a positive active material and an adhesive. A mass percentage of the adhesive in the positive active material layer is a. The electrolyte includes FSI⁻ ions, and a mass percentage of the FSI⁻ ions to all anions in the electrolyte is b. The positive electrode plate further includes an AlF₃ protective layer located between the positive current collector and the positive active material layer. The AlF₃ protective layer has a thickness of c micron, where a, b, and c satisfy 3%≤a+b*c≤34%.

### CROSS-REFERENCE TO RELATED APPLICATIONS

This application claims the priority of the Chinese Patent Application No. 2023112438035, filed on Sep. 25, 2023, which is incorporated herein by reference in its entirety.

### FIELD

The present disclosure relates to the technical field of batteries, and more particularly, to a lithium ion battery and an energy storage device.

### BACKGROUND

In the related art, when a battery, particularly a lithium ion battery with a high capacity (280 Ah or higher), is overcharged, a large amount of Joule heat and reaction heat is generated during overcharging, resulting in an increase in the battery temperature. The increased battery temperature may lead to a rupture of a solid electrolyte interface (SEI) of a negative electrode of the battery. Subsequent to the rupture of SEI, lithium graphite may react with an electrolyte to generate more heat. The increased battery temperature may also cause a contraction of a separator between a positive electrode plate and a negative electrode plate of the battery under heat, thereby resulting in the thermal runaway of the battery due to the short circuit of the positive electrode and the negative electrode. In addition, the heat generated in the overcharging may diffuse in the module and spread to adjacent batteries, which may lead to the destruction of battery structure or safety accidents if the batteries have poor heat resistance. Therefore, the overcharging and heat resistance of the battery, particularly of the high-capacity battery, should be urgently studied and solved, in order to ensure the safe and reliable operation of the battery.

### SUMMARY

In a first aspect, the present disclosure provides a lithium ion battery. The present disclosure includes a positive electrode plate, a negative electrode plate, a separator, and an electrolyte. The separator is located between the positive electrode plate and the negative electrode plate. The positive electrode plate includes a positive current collector and a positive active material layer covering the positive current collector. The positive active material layer includes a positive active material and an adhesive. A mass percentage of the adhesive in the positive active material layer is a. The electrolyte includes FSI⁻ ions, and a mass percentage of the FSI⁻ ions to all anions in the electrolyte is b. The positive electrode plate further includes an AlF₃ protective layer located between the positive current collector and the positive active material layer. The AlF₃ protective layer has a thickness of c micron, where a, b, and c satisfy 3%≤a+b*c≤34%.

In a second aspect, the present disclosure provides an energy storage device. The energy storage device includes the lithium ion battery according to the embodiments of the present disclosure in the first aspect.

Additional aspects and advantages of the embodiments of the present disclosure may be given at least in part in the following description, or become apparent at least in part from the following description, or can be learned from practicing of the embodiments of the present disclosure.

### DETAILED DESCRIPTION

Embodiments of the present disclosure may be described in detail below with reference to examples thereof as illustrated in the accompanying drawings, throughout which the same or similar elements, or elements having the same or similar functions, are denoted by same or similar reference numerals. The embodiments described below with reference to the drawings are illustrative only, and are intended to explain, rather than limiting, the present disclosure.

The present disclosure aims to solve at least one of the technical problems in the related art. To this end, an object of the present disclosure is to provide a lithium ion battery having less reaction heat, reduced internal resistance, good thermal stability and heat resistance. Thus, the reliability and safety of the lithium ion battery can be improved, and the overall electrical performance of the lithium ion battery is good.

According to embodiments of the present disclosure in a first aspect, a lithium ion battery includes a positive electrode plate, a negative electrode plate, a separator, and an electrolyte. The separator is located between the positive electrode plate and the negative electrode plate. The positive electrode plate includes a positive current collector and a positive active material layer covering the positive current collector. The positive active material layer includes a positive active material and an adhesive. A mass percentage of the adhesive in the positive active material layer is a. The electrolyte includes FSI⁻ ions, and a mass percentage of the FSI⁻ ions to all anions in the electrolyte is b. The positive electrode plate further includes an AlF₃ protective layer located between the positive current collector and the positive active material layer. The AlF₃ protective layer has a thickness of c micron, where a, b, and c satisfy 3%≤a+b*c≤34%.

For the lithium ion battery according to the embodiments of the present disclosure, by adding the adhesive at the mass percentage a into the positive active material layer, the oxidation resistance of the positive electrode during overcharging can be increased, and the reaction heat can be reduced; by adding the FSI ions at the mass percentage b with respect to all anions in the electrolyte, the conductivity can be increased and the Joule heat can be reduced, while the lithium ion battery has high thermal stability and the heat resistance of the battery cell can be increased; and by providing the AlF₃ protective layer with the thickness of c micrometers between the positive current collector and the positive active material layer, the safety hazards, which are caused by the corrosion of the positive current collector with FSI⁻ ions, can be prevented. When a, b, and c satisfy 3%≤a+b*c≤34%, the lithium ion battery can have less overall reaction heat, reduced internal resistance, and good thermal stability and heat resistance. Thus, the reliability and safety of the lithium ion battery can be improved, and the overall electrical performance of the lithium ion battery is better.

The lithium ion battery according to embodiments of the present disclosure is described below. The battery according to the embodiments of the present disclosure may be a lithium ion battery with a high capacity (280 Ah and above).

According to the embodiments of the present disclosure in a first aspect, the lithium ion battery includes a positive electrode plate, a negative electrode plate, a separator, and an electrolyte. The separator is located between the positive electrode plate and the negative electrode plate. The electrolyte may include a solvent and a lithium salt, and the electrolyte may further include an additive.

The positive electrode plate includes a positive current collector and a positive active material layer covering the positive current collector. The positive active material layer includes a positive active material and an adhesive configured to bond the positive active material together. The positive active material may include LiFePO₄. The adhesive may be polyvinylidene fluoride (PVDF). The positive active material layer further includes a conductive agent configured to increase a conductivity of the positive active material layer, and the conductive agent may be Super P (conductive carbon black).

In an overcharging process of the lithium ion battery, ions with strong oxidizing ability exist in a delithiated positive active material formed after delithiation of the positive active material. If the ions with strong oxidizing ability in the positive active material are in contact with the electrolyte, the ions can react with some solvents in the electrolyte. Thus, some solvent molecules in the electrolyte may undergo an oxidative ring-opening polymerization reaction to generate heat. For example, when the positive active material includes LiFePO₄, LiFePO₄ can be delithiated to form FePO₄ in the overcharging process of the lithium ion battery. During such a process, Fe²⁺ can be oxidized to Fe³⁺. It is well known that Fe³⁺ has a strong oxidizing ability. Fe³⁺ can cause the oxidative ring-opening polymerization of some solvent molecules in the electrolyte to generate heat. For example, when the solvents in the electrolyte include ethylene carbonate and propylene carbonate, Fe³⁺ enable ethylene carbonate and propylene carbonate in the electrolyte to undergo the oxidative ring-opening polymerization to generate heat.

The mass percentage of the adhesive in the positive active material layer is a. The adhesive can not only bond the positive active material together, but also coat an outer surface of the positive active material. The adhesive coated on the outer surface of the positive active material can effectively isolate the ions with strong oxidizing ability in the positive active material from contacting the electrolyte through an isolation effect of the adhesive. In this way, the contact between the ions with strong oxidizing ability in the positive active material and the electrolyte is reduced, and thus the heat generation caused by the oxidative ring-opening polymerization of some solvent molecules in the electrolyte is reduced, thereby reducing the reaction heat generated between the positive active material and the electrolyte.

Since the adhesive coated on the outer surface of the positive active material can effectively isolate the ions with strong oxidizing ability in the positive active material from contacting the electrolyte, the mass percentage of the adhesive in the positive active material layer can be appropriately increased. In this way, a coating area of the adhesive on the positive active material can be increased to reduce the contact between the ions with strong oxidizing ability in the positive active material and the electrolyte, thereby reducing the generated reaction heat. However, as an inactive material, a proportion of the adhesive should not be too much, otherwise it may affect the energy density of the lithium ion battery.

In another exemplary embodiment of the present disclosure, a lithium salt concentration in the electrolyte may range from 0.8 Mol/L to 1.2 Mol/L. For example, the lithium salt concentration in the electrolyte may be 0.8 Mol/L, 0.9 Mol/L, 1.0 Mol/L, 1.1 Mol/L, 1.2 Mol/L, etc. When the lithium salt concentration in the electrolyte is smaller than 0.8 Mol/L, the lithium salt concentration in the electrolyte is too low to result in a low ion concentration in the electrolyte, thereby leading to a low conductivity of the electrolyte. When the lithium salt concentration in the electrolyte is greater than 1.2 Mol/L, the lithium salt in the electrolyte cannot be fully dissolved. On the one hand, the lithium salt cannot be fully utilized to improve the conductivity, and thus the conductivity of the electrolyte is not high enough as a whole. On the other hand, lithium salt is wasted. By setting the lithium salt concentration in the electrolyte in the range from 0.8 Mol/L to 1.2 Mol/L, the amount of lithium salt is appropriate without causing waste, while ensuring a high conductivity of the electrolyte.

The lithium salt in the electrolyte may include LiFSI, and the lithium salt in the electrolyte may further include other lithium salts. For example, in addition to the FSI ions included in the electrolyte, the anions in the electrolyte may further include at least two of PF₆⁻, PO₂F₂⁻, F⁻, and SO₄²⁻.

As an example, in addition to the FSI⁻ ions included in the electrolyte, the anions in the electrolyte may further include two anions of PF₆⁻, PO₂F₂⁻, F⁻, and SO₄²—. For example, the anions in the electrolyte may include FSI⁻, PF₆⁻, and PO₂F₂; or the anions in the electrolyte may include FSI⁻, PF₆⁻, and F⁻; or the anions in the electrolyte may include FSI⁻, PF₆⁻, and SO₄²⁻.

As another example, in addition to the FSI⁻ ions included in the electrolyte, the anions in the electrolyte may further include two or three anions of PF₆⁻, PO₂F₂⁻, F⁻, and SO₄²⁻. For example, the anions in the electrolyte may include FSI⁻, PF₆⁻, PO₂F₂⁻, and F⁻; or the anions in the electrolyte may include FSI⁻, PF₆⁻, PO₂F₂, and SO₄²⁻.

As another example, in addition to the FSI ions included in the electrolyte, the anions in the electrolyte may further include PF₆⁻, PO₂F₂⁻, and SO₄²⁻.

The lithium salt in the electrolyte may include LiFSI, i.e. the electrolyte includes FSI ions. The LiFSI has a larger anion group than other commonly used lithium salts such as LiPF₆. Since LiFSI is easier to dissociate Li⁺ in the electrolyte, the LiFSI enable the electrolyte to have a higher conductivity. By adding an appropriate amount of LiFSI, the diffusion impedance of the Li can be effectively reduced. Therefore, the electrical performance of the lithium ion battery can be improved, and Joule heat generated during the charging of the lithium ion battery can be reduced due to the reduced impedance.

In combination with the above mass percentage of the adhesive in the active material layer, the reaction heat can be reduced, while the reaction heat and Joule heat can be reduced. Therefore, the heat generated during the overcharging of the lithium ion battery can be reduced, and a temperature rise of the lithium ion battery can be reduced. Due to the reduced temperature rise of lithium ion battery, the risk of the SEI rupture can be lowered and the stability of the SEI can be improved. As a result, the more heat generated due to the SEI rupture is prevented, and the thermal runaway of the battery, which is caused by the short circuit of the positive electrode and the negative electrode due to the thermal contraction of the separator between the positive electrode plate and the negative electrode plate, can be reduced. Since the heat generated in the battery is reduced, the damage of battery structure or occurrence of safety accidents can be prevented by inhibiting excessive heat transferred to adjacent batteries. Therefore, with such a setting, the reliability and safety of the lithium ion battery is improved, and the lithium ion battery has better electrical performance.

At the same time, the LiPF₆ is easily decomposed under heat to form LiF and PF₅. PF₅, as a strong Lewis acid, can react with trace H₂O in the electrolyte to form HF, thereby destroying the SEI. Therefore, by adjusting a ratio of FSI⁻ anions, the impedance can be significantly reduced and the SEI stability can be increased.

However, the positive current collector may be corroded by LiFSI when a charging voltage of the battery is higher than 4V. For example, when the positive current collector is aluminum foil, the aluminum foil is corroded by LiFSI, and Al(FSI)₃ formed by LiFSI and aluminum foil can be dissolved in the electrolyte, which causes safety hazards. Therefore, the amount of LiFSI is required to be controlled. In this regard, the mass percentage of FSI ions to all anions in the electrolyte is set to be b.

In order to prevent LiFSI in the electrolyte from corroding the positive current collector, a protective layer is arranged between the positive active material and the positive current collector. The protective layer can prevent the electrolyte from corroding the positive current collector. For example, the protective layer may be an AlF₃ protective layer. The protective layer may be pre-coated on the positive current collector, or the protective layer can be generated by a reaction of the positive current collector with the LiPF₆. For example, when the protective layer is the AlF₃ protective layer, the positive current collector is an aluminum foil, and the electrolyte includes lithium salt LiPF₆, such that the AlF₃ protective layer can be formed on a surface of the positive current collector. By providing the protective layer between the positive current collector and the positive active material, the electrolyte can be prevented from corroding the positive current collector, thereby improving the safety. However, it is required that the protective layer has an appropriate thickness. An excessively small thickness of the protective layer cannot serve as a good barrier. When the thickness of the protective layer is excessively thick, the protective layer has a relatively poor conductivity compared with the positive current collector. Thus, the conductivity is affected, and the internal resistance is increased. Therefore, the thickness of the protective layer is required to be set within an appropriate range. The thickness of the protective layer is set to be c micrometers.

Further, a, b, and c satisfy 3%≤a+b*c≤34%. For example, a value of a+b*c may be 3%, 7%, 10%, 13%, 17%, 20%, 22.5%, 27%, 30%, 34%, etc. By limiting a relationship of a, b, and c, a, b, and c can be set within appropriate ranges. By adding the adhesive at the mass percentage a into the positive active material layer, the oxidation resistance of the positive electrode during overcharging can be increased, and the reaction heat can be reduced. By adding the FSI⁻ ions at the mass percentage b with respect to all anions in the electrolyte, the conductivity can be increased and the Joule heat can be reduced, while the lithium ion battery has high thermal stability and the heat resistance of the battery cell can be increased. By providing the AlF₃ protective layer with the thickness of c micrometers between the positive current collector and the positive active material layer, the safety hazards, which are caused by the corrosion of the positive current collector with FSI⁻ ions, can be prevented. When a, b, and c satisfy 3%≤a+b*c≤34%, the lithium ion battery can have less overall reaction heat, reduced internal resistance, and good thermal stability and heat resistance. Thus, the reliability and safety of the lithium ion battery can be improved, and the overall electrical performance of the lithium ion battery is better.

When a+b*c<3%, the proportion of the adhesive is too low to coat LiFePO₄ particles. In this case, charged Fe³⁺ is very likely to oxidize EC or PC cyclic carbonate, which leads to the heat generation of the battery cell. In addition, due to the small thickness of the AlF₃ protective layer, the AlF₃ protective layer cannot sufficiently protect the current collector from FSI⁻ corrosion under high pressure, which very easily causes safety hazards. When a+b*c>34%, the higher proportion of the adhesive may lead to a decrease in the proportion of LiFePO₄ active material. Consequently, the energy density of the battery cell may also decrease. At the same time, an increase in the thickness of the AlF₃ protective layer may result in an increase in the impedance of the battery cell, which may also increase the Joule heat of the battery cell and cause safety hazards to the battery cell.

For the lithium ion battery according to the embodiments of the present disclosure, by adding the adhesive at the mass percentage a into the positive active material layer, the oxidation resistance of the positive electrode during overcharging can be increased, and the reaction heat can be reduced; by adding the FSI ions at the mass percentage b with respect to all anions in the electrolyte, the conductivity can be increased and the Joule heat can be reduced, while the lithium ion battery has high thermal stability and the heat resistance of the battery cell can be increased; and by providing the AlF₃ protective layer with the thickness of c micrometers between the positive current collector and the positive active material layer, the safety hazards, which are caused by the corrosion of the positive current collector with FSI⁻ ions, can be prevented. When a, b, and c satisfy 3%≤a+b*c≤34%, the lithium ion battery can have less overall reaction heat, reduced internal resistance, and good thermal stability and heat resistance. Thus, the reliability and safety of the lithium ion battery can be improved, and the overall electrical performance of the lithium ion battery is better.

According to some embodiments of the present disclosure, a, b, and c satisfy 7%≤a+b*c≤22.5%. For example, the value of a+b*c may be 7%, 10%, 13%, 17%, 20%, 22.5%, etc. By further limiting the relationship between a, b, and c, a, b, and c can be set within more appropriate ranges. Therefore, the lithium ion battery, as a whole, has less reaction heat, lower internal resistance, and better thermal stability and heat resistance. That is, the stability and safety of the lithium ions are higher, and the overall performance is better.

According to some embodiments of the present disclosure, a satisfies 2%≤a≤4%. For example, a value of a may be 2%, 2.2%, 2.5%, 2.8%, 3.0%, 3.2%, 3.5%, 3.8%, 4%, etc. When the mass percentage of the adhesive in the positive active material layer is set to be smaller than 2%, the content of the adhesive is excessively small, such that the adhesive cannot be effectively coated on the outer surface of the positive active material. As a result, during overcharging, the ions with strong oxidizing ability in the positive active material may react with some solvent molecules in the electrolyte and generate more heat. When the mass percentage of adhesive in the positive active material layer is set to be greater than 4%, the content of the adhesive is excessively great, resulting in a lower energy density of the battery. By setting the mass percentage of the adhesive in the positive active material layer in the range from 2% and 4%, the adhesive can be effectively coated on the outer surface of the positive active material, thereby effectively reducing the reaction between the ions with strong oxidizing ability in the positive active material and some solvent molecules in the electrolyte; and the energy density of the lithium ion battery can be guaranteed, such that the overall performance of the lithium ion battery can be improved.

According to some embodiments of the present disclosure, b satisfies 10%≤b≤60%. For example, a value of b may be 10%, 15%, 19%, 23%, 27%, 31%, 35%, 39%. 43%, 48%, 52%, 56%, 60%, etc. If the mass percentage b of the FSI⁻ ions to all anions in the electrolyte is smaller than 10%, the content of the FSI ions in the electrolyte is excessively low, resulting in relatively high diffusion impedance of the electrolyte. If the mass percentage b of the FSI⁻ ions to all anions in the electrolyte is greater than 60%, the content of the FSI⁻ ions in the electrolyte is excessively high, and the excessively high concentration of the FSI⁻ ions may easily corrode the positive current collector when the charging voltage is greater than 4V. By setting the mass percentage b of the FSI⁻ ions to all anions in the electrolyte in the range from 10% and 60%, the diffusion impedance of the electrolyte can be improved, and the corrosion of the positive current collector with the electrolyte can also be reduced.

According to some embodiments of the present disclosure, c satisfies 0.1≤c≤0.5. For example, a value of c may be 0.1, 0.15, 0.2, 0.25, 0.3, 0.35, 0.4, 0.45, 0.5, etc. When the thickness c of the protective layer is smaller than 0.1, the thickness of the protective layer is too thin to serve as a good barrier, and the risk of corrosion of the positive current collector by the electrolyte is still high. When the thickness c of the protective layer is greater than 0.5, the thickness of the protective layer is excessively thick, due to the relatively poor conductivity of the protective layer compared with the positive current collector, the conductivity may be affected and the internal resistance may be increased. By setting the thickness c of the protective layer in the range from 0.1 and 0.5, the electrolyte can be effectively prevented from corroding the positive current collector, thereby improving safety, and the overall conductivity of the positive electrode plate is better.

According to embodiments of the present disclosure in a second aspect, an energy storage device includes the lithium ion battery according to the embodiments of the present disclosure in the first aspect.

For the energy storage device according to the embodiments of the present disclosure, the reliability and safety of the energy storage device can be improved due to the less reaction heat, reduced internal resistance, and good thermal stability and heat resistance of the lithium ion battery.

The lithium ion battery according to the embodiments of the present disclosure may be further described below in conjunction with examples and comparative examples.

Preparation of lithium ion battery for testing: lithium ion batteries of respective examples and comparative examples were prepared based on the following methods.

Preparation of positive electrode plate: a positive active material (including LiFePO₄ material), a conductive carbon black, and an adhesive polyvinylidene fluoride (PVDF) were mixed to prepare a positive electrode slurry, in which a mass ratio of LiFePO₄ to conductive carbon black was 97.5:0.5, and in which a content of the adhesive was shown in Table 1; and the positive electrode slurry was coated on a positive current collector (such as aluminum foil) and rolled to form a positive active material layer, thereby preparing the positive electrode plate.

Preparation of negative electrode plate: a negative electrode active material (including graphite), a conductive carbon black, and an adhesive were mixed at a ratio of 96.7:0.8:2.5 to prepare a negative electrode slurry; and the negative electrode slurry was coated on a negative current collector (such as copper foil) and rolled to form a negative active material layer, thereby preparing the negative electrode plate.

Preparation of electrolyte: LiPF₆ and LiFSI were dissolved in an organic solvent to prepare the electrolyte. The lithium salt concentration in the electrolyte was 1 mol/L.

Preparation of separator: a polypropylene film of 16 micrometers was selected.

The above-mentioned positive electrode plate, separator, and negative electrode plate were sequentially stacked such that the separator was disposed between the positive electrode plate and the negative electrode plate to isolate the positive electrode plate and the negative electrode plate. The lithium ion battery was assembled by adding the above-mentioned electrolyte.

The lithium ion batteries of the respective examples and comparative examples were prepared with the above preparation method, and they differ from each other in the values of a, b, and c.

Differential scanning calorimetry (DSC) test and direct current resistance (DCR) test were performed on the lithium ion batteries prepared in the respective examples and comparative examples, respectively.

Method of DSC test: including a heat generation test of positive electrode and electrolyte and a heat generation test of negative electrode and electrolyte.

Heat generation test of positive electrode and electrolyte:
Step 1: a LiFePO₄ positive electrode plate was taken after full charge, and 1.9 mg of powder was scraped from the positive electrode plate. (Definition of full charge: charging to a voltage 3.65 V at a multiplication rate 0.5 P (448 W) at an ambient temperature of 25° C.)
Step 2: 1.1 mg of the electrolyte and 1.9 mg of the positive electrode powder were placed in a crucible and mixed in a glove box (in high purity argon atmosphere), and the crucible was subsequently sealed from the air.
Step 3: a temperature was set in a range from 30° C. to 350° C., with a temperature increase rate of 5° C./min and a N₂ flow rate of 50 mL/min.
Step 4: a resulting peak graph was integrated to calculate heat generated by the positive electrode and the electrolyte. The calculated heat generated by the positive electrode and the electrolyte was in units of J/g. The heat generated by the positive electrode and the electrolyte was a ratio of a total heat generated by the positive electrode and the electrolyte to the positive electrode and the electrolyte.

Heat generation test of negative electrode and electrolyte:
Step 5: a graphite negative electrode plate was taken after full charge, and 1.3 mg of powder was scraped from the negative electrode plate. (Definition of full charge: charging to a voltage 3.65 V at a multiplication rate 0.5 P (448 W) at an ambient temperature of 25° C.)
Step 6: 1.7 mg of the electrolyte and 1.3 mg of the negative electrode powder were placed in a crucible and mixed in a glove box (in high purity argon atmosphere), and the crucible was subsequently sealed from the air.
Step 7: a temperature was set in a range from 30° C. to 350° C., with a temperature increase rate of 5° C./min and a N₂ flow rate of 50 mL/min.
Step 8, a resulting peak graph was integrated to calculate heat generated by the negative electrode and the electrolyte. The calculated heat generated by the negative electrode and the electrolyte was in units of J/g. The heat generated by the negative electrode and the electrolyte was a ratio of a total heat generated by the negative electrode and the electrolyte to the negative electrode and the electrolyte.

Direct current resistance (DCR) test at 50% state of charge (SOC):
The battery was placed in a thermostat at 25° C. and stood still for 2 hours, then discharged with 0.5 C (1 C=280 A) constant current to a voltage of 2.5 V. After 5 minutes of still standing, the battery was charged with 0.5 C constant current to a voltage of 3.65 V, and charged with a constant voltage to a current of 0.025 C. After 5 minutes of still standing, the battery was discharged with 0.1 C constant current to a voltage of 2.5 V, and at this time point, the capacity of the discharged battery was recorded as C₀. The battery was charged to 3.65 V with 0.5 C constant current, and charged with a constant voltage to a current of 0.025 C. After 5 minutes of still standing, the battery was discharged with 0.1 C₀ constant current for 5 hours. After 60 minutes of still standing, the voltage was recorded as V₁ at this time point. Thereafter, the battery was discharged with 1 C₀ constant current for 30 seconds, and at this time point, the voltage was recorded as V₂. DCR at 50% SOC of the battery was (V₁-V₂)/C₀.

Table 1 presents a, b, c, a+b*c of lithium ion batteries prepared in the respective examples and comparative examples, and data obtained by the DSC test and DCR test.

TABLE 1

| | | | | | | Heat | Heat |
|---|---|---|---|---|---|---|---|
| | | | | | | generation of | generation of |
| | Mass | Mass | | | | positive | negative |
| | percentage | percentage | Thickness | | Discharge | electrode and | electrode and |
| | of adhesive | of FSI⁻ ions | of AlF₃ | | DCR (50% | electrolyte | electrolyte |
| Example | a | b | c/μm | a + b*c | SOC)/mΩ | (J/g) | (J/g) |
| Example 1 | 2.0% | 10.0% | 0.1 | 3.00% | 0.50 | 287 | 531 |
| Example 2 | 2.5% | 22.5% | 0.2 | 7.00% | 0.48 | 256 | 503 |
| Example 3 | 3.0% | 35.0% | 0.3 | 13.50% | 0.44 | 234 | 498 |
| Example 4 | 3.5% | 47.5% | 0.4 | 22.50% | 0.47 | 278 | 487 |
| Example 5 | 4.0% | 60.0% | 0.5 | 34.00% | 0.49 | 290 | 523 |
| Comparative | 1.8% | 9.0% | 0.05 | 2.25% | 0.53 | 301 | 541 |
| example 1 | | | | | | | |
| Comparative | 4.5% | 70.0% | 0.55 | 43.00% | 0.48 | 340 | 723 |
| example 2 | | | | | | | |

Table 1 reveals that, when the value of a+b*c ranged from 3% to 34%, the value of a ranged from 2.5% to 3.5%, the value of b ranged from 10% to 60%, and the value of c ranged from 0.1 to 0.5, the discharge DCR of the lithium ion battery was low; and the heat generated by the positive electrode and the electrolyte as well as the heat generated by the negative electrode and the electrolyte were both low. Therefore, the reaction heat and Joule heat generated by the lithium ion battery during overcharging were low, and the impedance was low, having good electrical performance.

Moreover, when the value of a+b*c ranged from 7% to 22.5%, the value of a ranged from 2% to 4%, the value of b ranged from 22.5% to 47.5%, and the value of c ranged from 0.2 to 0.4, the discharge DCR of the lithium ion battery was lower; and the heat generated by the positive electrode and the electrolyte as well as the heat generated by the negative electrode and the electrolyte were both lower. Therefore, the reaction heat and Joule heat generated by the lithium ion battery during overcharging were low, and the impedance was low, having better electrical performance.

In the specification, description with reference to the terms “an embodiment”, “some embodiments”, “exemplary embodiments”, “examples” “specific examples”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although embodiments of the present disclosure have been illustrated and described, it is conceivable for those of ordinary skill in the art that various changes, modifications, replacements, and variations can be made to these embodiments without departing from the principles and concept of the present disclosure. The scope of the present disclosure shall be defined by the claims as appended and their equivalents.

What is claimed is:

1. A lithium ion battery, comprising:
a positive electrode plate comprising a positive current collector, a positive active material layer covering the positive current collector, and an AlF₃ protective layer located between the positive current collector and the positive active material layer, the positive active material layer comprising a positive active material and an adhesive, a mass percentage of the adhesive in the positive active material layer being a, and the AlF₃ protective layer having a thickness of c micrometers;
a negative electrode plate;
a separator located between the positive electrode plate and the negative electrode plate; and
an electrolyte comprising FSI⁻ ions, a mass percentage of the FSI⁻ ions to all anions in the electrolyte being b,
wherein a, b, and c satisfy 3%≤a+b*c≤34%.

2. The lithium ion battery according to claim 1, wherein a, b, and c satisfy 7%≤a+b*c≤22.5%.

3. The lithium ion battery according to claim 1, wherein a satisfies 2%≤a≤4%.

4. The lithium ion battery according to claim 1, wherein b satisfies 10%≤b≤60%.

5. The lithium ion battery according to claim 1, wherein c satisfies 0.1≤c≤0.5.

6. The lithium ion battery according to claim 1, wherein the positive current collector is an aluminum foil.

7. The lithium ion battery according to claim 1, wherein the positive active material comprises LiFePO₄.

8. The lithium ion battery according to claim 1, wherein the adhesive is polyvinylidene fluoride (PVDF).

9. The lithium ion battery according to claim 1, wherein the anions in the electrolyte further comprise at least two of PF₆⁻, PO₂F₂⁻, F⁻, and SO₄²⁻.

10. The lithium ion battery according to claim 1, wherein a lithium salt concentration in the electrolyte ranges from 0.8 Mol/L to 1.2 Mol/L.

11. An energy storage device, comprising a lithium ion battery, the lithium ion battery, comprising:
a positive electrode plate comprising a positive current collector, a positive active material layer covering the positive current collector, and an AlF₃ protective layer located between the positive current collector and the positive active material layer, the positive active material layer comprising a positive active material and an adhesive, a mass percentage of the adhesive in the positive active material layer being a, and the AlF₃ protective layer having a thickness of c micrometers;
a negative electrode plate;
a separator located between the positive electrode plate and the negative electrode plate; and
an electrolyte comprising FSI⁻ ions, a mass percentage of the FSI⁻ ions to all anions in the electrolyte being b,
wherein a, b, and c satisfy 3%≤a+b*c≤34%.

12. The energy storage device according to claim 11, wherein a, b, and c satisfy 7%≤a+b*c≤22.5%.

13. The energy storage device according to claim 11, wherein a satisfies 2%≤a≤4^{%}.

14. The energy storage device according to claim 11, wherein b satisfies 10% b≤60^{%}.

15. The energy storage device according to claim 11, wherein c satisfies 0.1≤c≤0.5.

16. The energy storage device according to claim 11, wherein the positive current collector is an aluminum foil.

17. The energy storage device according to claim 11, wherein the positive active material comprises LiFePO₄.

18. The energy storage device according to claim 11, wherein the adhesive is polyvinylidene fluoride (PVDF).

19. The energy storage device according to claim 11, wherein the anions in the electrolyte further comprise at least two of PF₆⁻, PO₂F₂⁻, F⁻, and SO₄²⁻.

20. The energy storage device according to claim 11, wherein a lithium salt concentration in the electrolyte ranges from 0.8 Mol/L to 1.2 Mol/L.
